(19) United States
(12) Patent Application Publication
(10) Pub. No.: US 2006/0277309 A1
(43) Pub. Date: Dec. 7, 2006

(54) Method and system for discovering antenna line devices

(75) Inventor: Lawrence E. Eaton, Buford, GA (US)

Correspondence Address: KING & SPALDING LLP, 1180 PEACHTREE STREET, ATLANTA, GA, 30309, US

(73) Assignee: EMS Technologies, Inc., Norcross, GA (US)

(21) Appl. No.: 11/446,682

(22) Filed: Jun. 5, 2006

Related U.S. Application Data
(60) Provisional application No. 60/687,417, filed on Jun. 3, 2005.

(51) Int. Cl. G06F 15/16

(52) U.S. Cl. 709/227

(57) ABSTRACT

A system and method for searching a communication bus or network for one or more Antenna Line Devices using a divide-and-conquer approach can efficiently identify devices on the network in a short period of time. A divide-and-conquer search over the desired address space of network devices may be assisted by intelligently updating queries used in the search to reduce unnecessary queries. The state of devices present on a subset of the network may be determined by intelligently analyzing responses to queries with respect to possible collision of the query responses. Repeated queries may be used to interrogate a network for devices in a significantly more efficient manner than by explicitly querying each possible address in the address space.

### PRIORITY CLAIM TO PROVISIONAL APPLICATION

This application claims priority to provisional patent application entitled, “Search Method for Antenna Line Devices” filed on Jun. 3, 2005 and assigned U.S. Application Ser. No. 60/687,417. The entire contents of the provisional patent application mentioned above are hereby incorporated by reference.

### TECHNICAL FIELD

The present invention is generally directed to network address searching, and relates more particularly to the efficient searching of device addresses within a network designed to support operations of an antenna supporting structure, such as an antenna tower.

### BACKGROUND OF THE INVENTION

The Antenna Interface Standards Group (AISG) was established in 2001 to create an open specification for the control interface of third generation (3G) and beyond antenna line products. The AISG protocol is designed to provide the means by which Antenna Line Devices (ALDs) with remote control and monitoring capabilities can be introduced while ensuring the basic interoperability between these products and the control infrastructure. ALDs can include antennas, amplifiers and associated equipment having remote control and monitoring features. This communication protocol uses a three-layered model comprising a physical layer, a data link layer and an application layer. The communication protocol usually operates over a communication bus.

The communication bus usually comprises an RS485 serial communication mode between one or more ALDs and a controller. The physical connection of ALDs to the RS485 serial bus is generally parallel. Such that all of the ALDs can be transmitted to at once using the same bus. The bus, such as an RS485 bus, can be considered a network. This network may be connected in any particular topology such as a star, bus, tree, or otherwise. Further, the ALDs may couple to the network using wired or wireless links. A scan algorithm can be used with the network to identify all connected ALDs, regardless of the physical connection or network topology. That is, the network may be scanned to identify and enumerate all ALDs coupled to the network.

The AISG specification contains a method for querying ALDs to identify unknown devices using various identifier (ID) information known to every ALD. Each ALD has a unique identifier (UID) and the controller must determine the UID of every ALD on the network in order to communicate commands to them. A UID can comprise a vendor ID and a product serial number. The entire UID, vendor ID, and/or the serial number may, in the most general sense, be alphanumeric characters or even non-displayable bit patterns.

One way to determine the UID of an ALD is through the use of a Device Scan Command and Device Scan Response that are supported by the AISG protocol. In order to issue a Device Scan Command, the controller usually generates a UID and a bit mask. The UID is the pattern the controller is querying the network about, and the bit mask tells the ALDs which parts of the UID must match. If the UID of the ALD matches, then the ALD sends the Device Scan Response containing its UID to the controller. The bit mask defines which bits to ignore in this procedure.

Through combinations of Device Scan Commands, a controller can identify all ALDs on the network. One conventional and simple, yet less sophisticated, method for accomplishing this would be to count through all possible UIDs issuing a query to search for the presence of each possible UID. This brute force approach to the problem would take far too long to discover each UID of all ALDs coupled to a network to be practical. The use of a bit mask within the Device Scan Command may enable interrogating larger subsets of the UID space with a single command, however, the methods for processing and interpreting potential response collisions in such an approach is not addressed by the standard.

That is, when there are two or more devices coupled to a network that supports operations of an antenna supporting structure, there is a likelihood that responses to a Device Scan Command can collide with one another. Since communication between the controller and the ALDs is generally asynchronous, the response collisions cannot be avoided with any real certainty until all ALDs coupled to a network have been identified and can be individually addressed.

During some collisions, the responses can overlap in such a manner that the responses may not be intelligible to the controller. In some instances, the responses can overlap slightly such that the controller may receive a valid response with a few extra characters. In other cases, one response could be overshadowed completely by another response such that the controller perceives only a single response, when in fact, two or more valid responses containing UIDs may exist.

Accordingly, there is a need in the art for a method and system that can reliably discover devices, such as ALDs, coupled to a network when two or more responses from respective devices may collide. Another need exists in the art for a method and system that can reliably discover devices, such as ALDs, coupled to a network in an efficient manner so that devices are identified in a short period of time.

### SUMMARY OF THE INVENTION

The inventive system and method may comprise a communication bus interconnecting one or more Antenna Line Devices (ALDs) and a controller. The controller may scan the communication bus to identify all connected ALDs. The inventive method scans the bus by transmitting queries onto the bus. ALDs connected to the bus may respond to these queries to notify the controller of the presence of the ALD on the network. The format of the queries may allow the controller to specify entire subsets of the network to query at one time. This allows for a divide-and-conquer search approach where a large subset of the network can be queried and if multiple ALDs respond from that subset, the subset can be further divided until the presence of individual ALDs may be resolved.

An example of such a divide-and-conquer approach can be a binary search. In a binary search embodiment, the search can begin by querying half of the network. If more than one ALD appears to be present in that half of the network, then that half can be divided in half again and then only one quarter of the network would be queried. This binary division, meaning division by two, of the network would continue until a single ALD is resolved.

A specific ALD can be identified by its unique identifier (UID). In an exemplary embodiment, the UID can have two parts, a vendor ID and a serial number. The queries discussed above, can query the UID of the ALDs connected to the network. The queries can basically inquire with the ALDs on the network about their UIDs. The query may supply a portion of a UID and effectively ask the ALDs if any of their UIDs contain that same portion. This may be considered similar to asking everyone in a room to raise their hand if their first name begins with the letter J.

Using queries of this nature, the subdividing of the network is actually dividing the network by UID, and not physically. The process of subdividing would be like specifying additional letters in the name query above. If ten people raised their hands in response to the first question, they might next be asked to keep their hands up if the first two letters are J and A. This would cause most or perhaps all of the participants responding affirmatively to their first letter being J to lower their hands. Jack and Jane would keep their hands raised, but Jill, Joan, Jesse, Jim, Josh, and Joe would not. Specifying more and more letters would further reduce the number of participants until each participant was uniquely identified.

Asking the hand-raising question with specific letters is similar to supplying the UID for the participants to compare their names to. Telling them how many letters of their name to match is similar to supplying a mask. A mask serves to mask off the remainder of the name so that only the portion currently being queried is compared to the supplied identifier.

Similarly, a network scan query supplies the ALDs with a UID to compare their own UID to. The scan query also supplies the ALDs with a bit mask that specifies which bits of the ALD's UID to compare with the UID supplied in the query.

The controller may broadcast the queries to all of the connected ALDs, but only those with UIDs that can be masked off to match the queried UID will respond. This is similar to how only those people having first names that can be masked off to one letter and then compared to equal the letter J would raise their hands. The question was asked to everyone but only those who met the requirements responded. If more than one participant responded, further subdivision (using the mask) can be used to attempt to reduce the number of responders. This may continue until every participant is uniquely identified. The benefit of this approach over asking about every possible name is that if no one raising their hands when asked for first letter T, then there is no reason to inquire further about Ted, Tom, Thomas, or Tina.

Using the example of discovering people's names, the search space is divided into twenty-sixths with each query specifying one or more of the twenty six letters used in the alphabet. When the alphabet used is bits (binary digits), which may be only either ONE or ZERO, the queries are most easily formed as to divide the search space into two. This is referred to as a binary search.

A query may include a bit mask and a UID. When each ALD receives a query, the ALD can apply the bit mask to its own UID and compare the result with the UID supplied in the query. If there is a match, the ALD can respond to the controller. If the controller receives no response, the controller will now have information that no ALD on the network has the queried bits in its UID. This can allow the controller to stop making queries further refining the last query made. For example if no UIDs have their first two bits equal to “01”, then there is no reason to query about UIDs “010”, “0111”, “0100001”, “0110111”, etc. Since no UIDs have the first two bits of “01” none of them could possibly be any of those other listed options.

One aspect of the inventive search method is the set of techniques for updating the queries issued by the controller. These techniques can explain when and how to modify the bit mask and the UID specified in the query. The approach for updating the queries may be viewed as two situations: subdividing to refine the query, and advancing to another subset. Subdividing to refine the query can be used when more than one ALD is responding to the present query. This is similar to specifying additional letters in the naming example noted above. Specifying an additional letter extends the mask by one letter and then adds a letter to the UID.

For example, updating the query from asking for names starting with the letter J to asking for names starting with the two letters J and A. This further subdivides the previous name-space by twenty-six and it refines the resolution on identifying specific names. In the binary search example, the mask can be extended to be one bit longer and the new bit is specified in the UID to start searching for ONE or ZERO in that position.

The query update for advancing to another subset can be performed when searching in the current subset is complete. For example, once all participants whose names start with the letter J have been identified, the query may be advanced to inquire about names starting with the letter K. In that example, the mask may not be modified at all (it remains one letter long), but the UID can be set to the next value. In a slightly more complicated example, if the last query were to “JZ”, the next might be to “K”.

The update did not proceed from “JZ” to “KA” because it is first prudent to query on all of “K”. If there are no responses for “K” then there is no need to separately query “KA”, “KB”, “KC”, etc. This update rule may be generalized as switching to the next subset the same length as the present subset, but if all subsets at the present length are complete, then reducing the length of the mask by one and advancing to the next subset at that reduced length. Thus, advancing “AMRC” yields “AMRD” , and advancing “AMRZ” yields “AMS”. Likewise, in the binary example, advancing “0100” yields “0101” and advancing “0101” yields “011”.

Another aspect of the inventive search method involves generalizing the ordering of progressing through a scan. For clarity, the previous name example proceeded from left to right like the English language. Adding another element to the mask can extend it one to the right and therefore placing the next character to the right into the pool to be considered during the scan queries. Even when the method for advancing the queries proceeds in this manner, it is possible to introduce a translation layer which can effectively scramble this left-to-right progression to appear to proceed in any arbitrary ordering. For example, the fifth bit may be specified first and then the third bit and then the twelfth but. The scan remains essentially the same because specifying an additional bit will further divide the search space into two regardless of where that bit is located.

This scrambling by the translation layer may be useful for generalizing the search approach but also for taking advantage of knowledge of the search space. Once again using the name example, this knowledge may be that more names start with the letter R than other letters. Thus it may be desirable to begin the scan with the letter R instead of beginning with A as in the simplified approach used in the example above. It may also be desirable to search for the third letter first instead of the first letter first. The translation layer can enable such arbitrary order of searching.

Generalizing the search order may be used to handle situations where some portions of the UID are not used by a specific ALD. This situation would be similar to someone not responding to any first letter of their name but this person would respond to the second letter of their name matching correctly. In such a case, searching for names with the first letter not specified may be required to get the person to respond. One way that this could be accomplished would be to start by asking about second letters instead of starting with first letters. Various other situations may benefit from an arbitrary ordering of the search sequence.

Yet another aspect of the inventive search method is the set of techniques for determining if the last query is still specifying more than one ALD and thus generating more than one response. When this happens, the responses are said to collide.

Three examples of how the controller can detect collisions between multiple responses may be considered: invalid response, response with extra characters, and shadowed response. An invalid response may occur when more than one response is being received at the same time and the responses interfere with one another becoming garbled. Since the controller may recognize a garbled response as an invalid response this may indicate a multiple response collision.

A “response with extra characters” can refer to a situation where a valid response is received but extra characters come along with the response. The extra characters may be from a second responder that was overpowered by the first responder instead of interfering with it. In this situation, the two responders are not garbling one another's responses but instead one of the responses is readily detected by the controller. Once the response from the first responder is completely received by the controller, the controller may also receive extra characters from a second responder. These characters may come either before the valid response from the first responder or after the valid response. The extra characters may result when the response from the second responder was partially overlapped by the first responder so the unobscured part of the second responder does not form a complete response but appears only as extra characters.

A shadowed response is very similar to the extra characters situation just described. That is, two responders are sending responses to the controller. However in this shadowed case, the second response is completely blocked out (or shadowed) by the received response. If the response being shadowed (i.e. being blocked out) begins after (or coincident with) the beginning of the first response, and ends before (or coincident with) the end of the first response, then there will be no extra characters received along with the first overpowering response. Thus, it will appear to the controller as though only one responder is responding.

The method for detecting this completely shadowed response can include the controller repeating, perhaps multiple times, any query that appears to have only one valid responder. The purpose for this repetition is that the second responder who was overpowered during the first query is usually less likely to respond at exactly the same time as the first responder twice in a row. The more times that the query is repeated, it is less likely that the two responders are exactly synchronized during every one of those queries. If during only one of those repetitions, the two responses are even a small amount out of synchronization, then the overlapping in time can cause extra characters to spill out on either side. This can then trigger the extra characters collision detection described above.

### BRIEF DESCRIPTION OF THE DRAWINGS

FIG. 1 is a functional block diagram illustrating antenna line devices mounted on an antenna tower and connected to a local controller and local and remote computers according to one exemplary embodiment of the invention.

FIGS. 2A-2C illustrate exemplary device scan command and response message structures according to one exemplary embodiment of the invention.

FIGS. 3A-3B illustrate exemplary unique identifiers and associated bit mask according to one exemplary embodiment of the invention.

FIG. 4 illustrates an exemplary binary search tree according to one exemplary embodiment of the invention.

FIG. 5 is a logic flow diagram highlighting exemplary steps for a search method according to one exemplary embodiment of the invention.

FIG. 6 is a logic flow diagram highlighting exemplary steps for a method to update a search query to advance a branch in a search tree according to one exemplary embodiment of the invention.

FIG. 7 is a logic flow diagram illustrating exemplary steps for a method to update a search query to search deep into a search tree according to one exemplary embodiment of the invention.

FIGS. 8A-8D illustrate four timing diagrams of possible response collision scenarios according to one exemplary embodiment of the invention.

FIG. 9 illustrates a bit translation map to generalize the search progression according to one exemplary embodiment of the invention.

FIG. 10 is a logic flow diagram illustrating exemplary steps for a coarse-to-fine search method according to one exemplary embodiment of the invention.

### DETAILED DESCRIPTION OF EXEMPLARY EMBODIMENTS

The inventive antenna line device search method can be used for identifying all Antenna Line Devices (ALDs) on a computer network designed to support operations of an antenna supporting structure, such as an antenna tower. The search method may be implemented in an embedded controller, on a computer, in dedicated hardware, or using some combination thereof. The search method may broadcast queries onto the network and analyze responses to those broadcasts to determine the unique identifiers (UIDs) of all connected ALDs. The search may seek to explore the entire address space which is all of the possible addresses for a given network. In one example, the addresses may be a UID made up of a vendor ID and a serial number. One of ordinary skill in the art would appreciate numerous other examples of network address representations without departing from the spirit or scope of the invention.

The search approach is one of a divide-and-conquer algorithm. The queries are directed to a broad subset of the possible address spaces. If no responses are received, then the subset can be considered unoccupied. If only one response is received then it is recorded and the search is continued in a different subset of the address space. If multiple or garbled responses are received then the present subset of the address space likely contains more than one responder and thus may be further divided into smaller subsets eventually isolating single responses.

One of ordinary skill in the art will appreciate that exemplary embodiments of the inventive method and system may comprise software or firmware code executing on a microcontroller, microprocessor, or DSP processor; state machines implemented in application specific or programmable logic; or numerous other forms without departing from the spirit and scope of the invention. The invention may be provided as a computer program which may include a machine-readable medium having stored thereon instructions which may be used to program a computer (or other electronic devices) to perform a process according to the invention.

The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

Certain steps in the processes or process flows described in all of the logic flow diagrams referred to below must naturally precede others for the invention to function as described. However, the invention is not limited to the order of the steps described if such order or sequence does not alter the functionality of the present invention. That is, it is recognized that some steps may be performed before, after, or in parallel with other steps without departing from the scope and spirit of the present invention.

Further, one of ordinary skill in the art would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer implemented processes will be explained in more detail in the following description in conjunction with the remaining Figures illustrating other logical process flows.

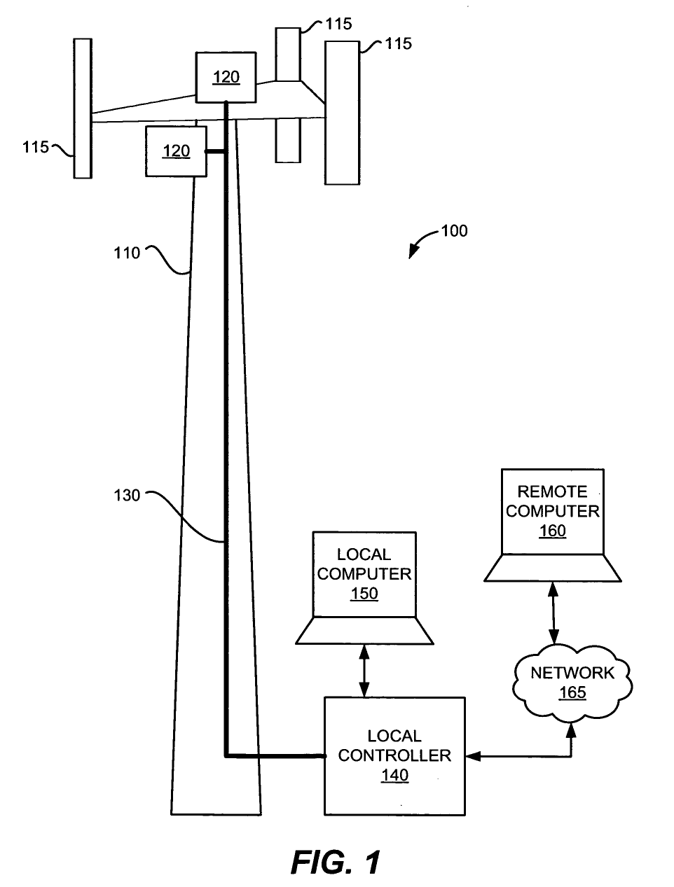

Turning now to the drawings, in which like reference numerals refer to like elements, FIG. 1 is a functional block diagram of a system 100 comprising Antenna Line Devices (ALDS) 120 mounted on an antenna tower 110. The ALDS 120 can be coupled to a local controller 140, local control computer 150, and remote control computer 160 according to one exemplary embodiment of the invention. The antenna tower 110 may support one or more antennas 115 and antenna line devices 120. The ALDs 120 may comprise power amplifiers, antennas, antenna tilt motors, devices for moving antennas, instrumentation, monitoring devices, sensors, phase delays, lights, alarms, programmable control devices, or any other devices related to the antenna system that may be controlled and/or monitored by at least one of the local controller 140, the local control computer 150, the remote control computer 160, or a combination thereof.

Local controller 140 may communicate electronically with ALDs 120 over connection 130. Connection 130 may be any type of communication link or communication network known to one of ordinary skill in the art. Connection 120 may be wired, wireless, or optical. One exemplary embodiment of connection 130 according to the AISG standard comprises a serial bus operating at 9600 bits per second and implementing a High-Level Data Link Control (HDLC) networking model. A second exemplary embodiment of connection 130 according to the AISG standard comprises a communication signal that is modulated onto the feed lines connecting to antennas 115 on the antenna tower 110. One of ordinary skill in the art will appreciate that other various embodiments of connection 130 based on communication link technology or communication network technology are not beyond the scope or spirit of the invention.

The local controller 140 may comprise the hardware and/or software for implementing the inventive search method. Alternatively, the local computer 150 may comprise part or all of the implementation of the inventive search method. In such a case, the local controller 140 may serve, entirely or in part, as an interface or gateway between the local computer 150 and ALDs 120 via the connection 130.

A remote computer 160 may also comprise part or all of the implementation of the search method. In such an embodiment, the local controller 140 may be in communication with the remote computer 160 via a computer network 165. The remote computer 160 may be used with or without a local computer 150. Likewise, the local computer 150 may operated with or without the remote computer 160. Further, the local controller 140 may operate with or without either or both of the computers 150 and 160.

Computer network 165 may comprise any one, or combination, of network systems known to one of ordinary skill in the art such as the Internet, a Local Area Network (LAN), or Wide Area Network (WAN) and it may be wired, wireless, optical, telephone, packet switched, circuit switched, or otherwise. The local controller 140 may serve, entirely or in part, as an interface or gateway between the remote computer 160 (and the network 165) and antenna line devices 120 via the communication link or network comprising connection 130.

The search method may also be distributed between any combination of the local controller 140, local computer 150, or remote computer 160. Local computer 150 and remote computer 160 may also either be capable of configuring each other and/or the local controller 140. This configuration may comprise the operation, updating, replacing, or adjusting of software or firmware components.

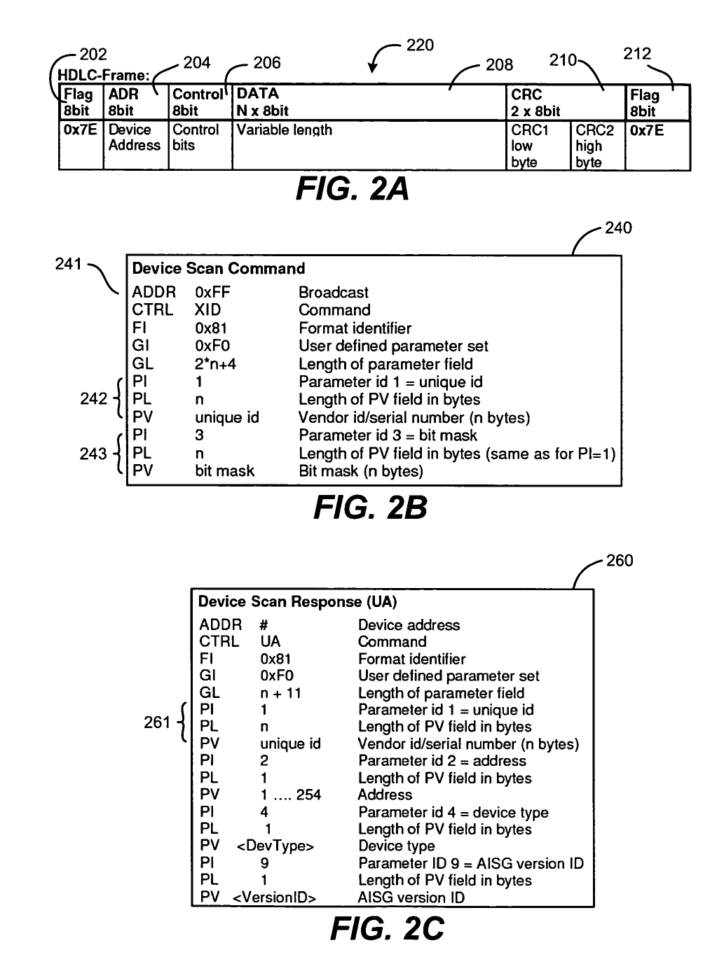

Referring now to FIG. 2A, the Figure illustrates the general format of a High-Level Data Link Control (HDLC) frame 220. In one exemplary embodiment of the invention, the fields of an HDLC frame 220 can be set accordingly to send a scan command from local controller 140 to antenna line devices 120. ALDs 120 may respond to local controller 140 by sending a response HDLC frame 220 with the fields set appropriately. The flag field 202 and 212 of HDLC frame 220 may be used between frames 220 and thus appears at the beginning and end of and frame 220. The flag field 202 and 212 can always set to hexadecimal value “7E” so that it is always identified as the demarcation between frames. The address field 204 of the HDLC frame 220 may specify where a command is going to or where a response is coming from. The address field 204 of a command may also be filled in with the hexadecimal value of “FF” to indicate that it is broadcast. A broadcast frame 220 should be received by all devices on the network. A command sent to a specific address is only received by the ALD 120 with that specific address, but address 0xFF indicates a broadcast that all ALDs 120 should receive.

The control field 206 of HDLC frame 220 may be used to specify the type of frame. In one exemplary embodiment, the control field 206 of a frame containing a Device Scan Command is filled in with “XID” and for a Device Scan Response with “UA”. The data field 208 of HDLC frame 220 may be used to carry the actual payload of informational content of the frame. For example, the data field 208 of a frame for a Device Scan Command may comprise the UID and the bit mask to be queried. Likewise, the data field 208 of a frame for a Device Scan Response may comprise the actual UID of the device that is responding. The Cyclic Redundancy Check (CRC) field 210 of the HDLC frame 220 is used store a check value that is calculated over the entire frame. The sender of the frame 220 computes the CRC and places it in the frame 220 before sending it. The receiver of the frame computes the CRC again and verifies it against the received CRC. If there two do not match, it may be assumed that there was an error in the transmission of the frame and the frame may be discarded in a condition referred to as a CRC failure. The methods for computing a two byte (16 bit) CRC (also known as a CRC-16) are well known in the art.

Referring now to FIG. 2B, table 240 illustrates how the fields of the HDLC frame 220 may be filled in for issuing a Device Scan Command from local controller 140 to ALDs 120. The Device Scan Command can be used to query the ALDs 120 with a UID and a bit mask. As specified at entry 241 of table 240, the address field 204 of the HDLC frame 220 is filled in with hexadecimal value “FF” indicating a broadcast.

In constructing an HDLC frame 220 to be used for issuing a Device Scan Command, the controller 140 may place two parameters into the data field 208 of the HDLC frame 220. The first parameter, as detailed at entry 242 of table 240 is the UID. The Parameter ID (PI) has the value of one, the value that designates the parameter as the UID. The Parameter Length (PL) is specified as n to allow the controller 140 to place in the exact length of the UID that it is sending in the command. The Parameter Value (PV) is that actual UID whose length was placed into the PI position.

The second parameter, as detailed at entry 243 of table 240 is the bit mask. The Parameter ID (PI) has the value of three, the value that designates the parameter as the bit mask. The Parameter Length (PL) is specified as n to allow the controller 140 to place in the exact length of the mask that it is sending in the command. This n is the same length that was used with the UID above since the bit mask and UID should be the same length. The Parameter Value (PV) is that actual bit mask.

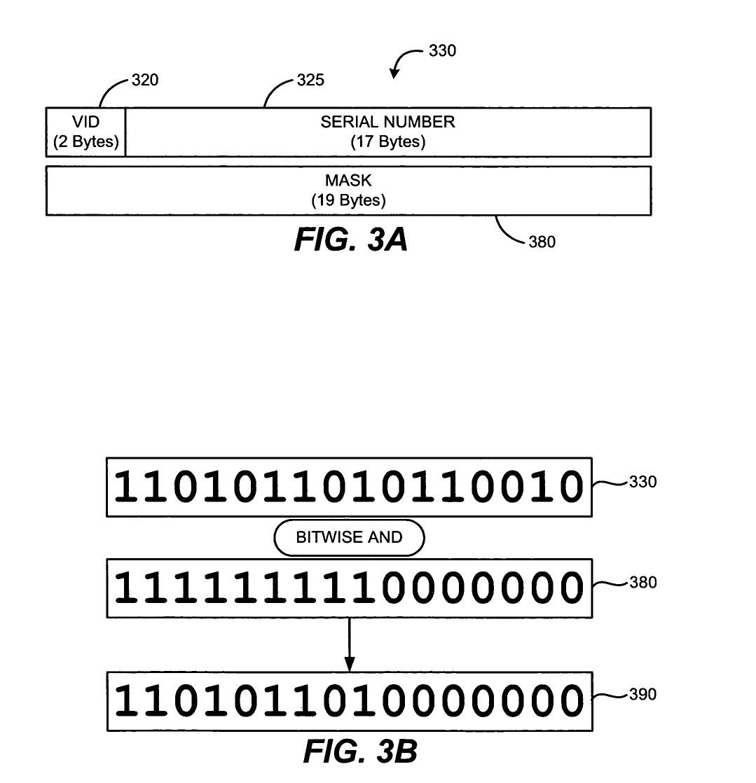

Referring now to FIG. 2C, table 260 illustrates how the fields of the HDLC frame 220 may be filled in for forming a Device Scan Response. This response may be sent to the local controller 140 from an ALD 120 in response to the ALD 120 receiving a Device Scan Command query. The ALD 120 responds with a Device Scan Response only if its UID matches the UID of the query subject to the application of the bit mask from the query. This matching process is detailed in relation to FIG. 3B.

In constructing an HDLC frame 220 to be used for issuing a Device Scan Response, the responding ALD 120 must include its actual UID. A parameter of the response for specifying this actual device UID is detailed at entry 261 of table 260. The Parameter ID (PI) for this parameter has the value of one, the value that designates the parameter as the UID. The Parameter Length (PL) is specified as n to allow the ALD 120 to place in the exact length of its UID that it is sending in the response. The Parameter Value (PV) is that actual UID whose length was placed into the PI position. It is important to appreciate that the UID of the ALD 120 provided in parameter 261 of the Device Scan Response need not exactly equal the UID that was contained in the Device Scan Command query. Only the bits of the actual UID that correspond to non-zero bits of the bit mask need match the queried UID. This matching process is detailed in relation to FIG. 3B. Thus, a Device Scan Response from an ALD 120 sent to the local controller 140 must supply a UID since the UID received from the ALS 120 by the controller 120 may not be exactly the UID that was originally queried by the controller 140.

The command and response structures outlined in FIG. 2A, FIG. 2B, and FIG. 2C are merely exemplary and are not intended to be limiting. These examples relate generally to AISG standard version 1.1. Embodiments using scan commands and responses as specified in future versions of this standard or other related standards, either formal or de facto, may differ in implementation and formatting specifics from these examples without departing from the spirit or scope of the inventive search and enumeration methods.

One of ordinary skill in the art will appreciate that many other structures of query commands and responses can be employed in alternate embodiments without departing from the scope or spirit of the invention. The essential components of the command and response structure may comprise a query UID and a bit mask that indicates which bits of the UID to match against. Alternatively to using a bit mask, any other indicator of a specific subset of the UID space may be employed in place of, or in addition to, a bit mask.

Referring now to FIG. 3A, this Figure illustrates a unique identifier (UID) 330 and an associated bit mask 380 according to one exemplary embodiment of the invention. In this example, the UID 330 is the concatenation of a two byte Vendor ID (VID) 320 and a seventeen byte serial number 325. These two fields combine to form a nineteen byte long UID 330. As discussed above, the bit mask 380 may be used to indicate which bits of the UID 330 in the query must match the same bits in the UID 330 of the ALD 120. Only if the bits of the UID 330 of the ALD 120 that are also set in the bit mask 380 match the UID 330 being queried does the ALD 120 respond to the query. This process of only consider bits that are set in the bit mask 380 is mathematically referred to as performing a bitwise-AND. An example of this process is detailed in FIG. 3B.

Referring now to FIG. 3B, this Figure illustrates a bitwise-AND application of a bit mask 380 to a UID 330 according to one exemplary embodiment of the invention. The resultant value 390 is clearly a copy of the UID 330 that has been masked off by the bit mask 380. Each bit of the resultant value is equal to applying a logical AND operation to the corresponding bit in the UID 330 and the corresponding bit in the bit mask 380. Thus, a bit in result 390 is only set to ONE when the same bit in ID 330 is set to ONE “AND” the same bit in mask 380 is set to ONE. This bit-by-bit application of the logical AND operator is referred to as bitwise-AND.

When an ALD 120 receives the Device Scan Command, the ALD 120 can respond to the local controller 140 with a Device Scan Response if, and only if, its UID matches the query. The UID of an ALD 120 is said to match the query of a Device Scan Command when the bitwise-AND of the UID of the ALD 120 and the bit mask in the query is equal to the UID specified in the query. In other words, the two UIDs 330 are compared but only bits that are also set in the bit mask 380 are considered in the comparison. The other bits are considered to be masked off by the bit mask 380.

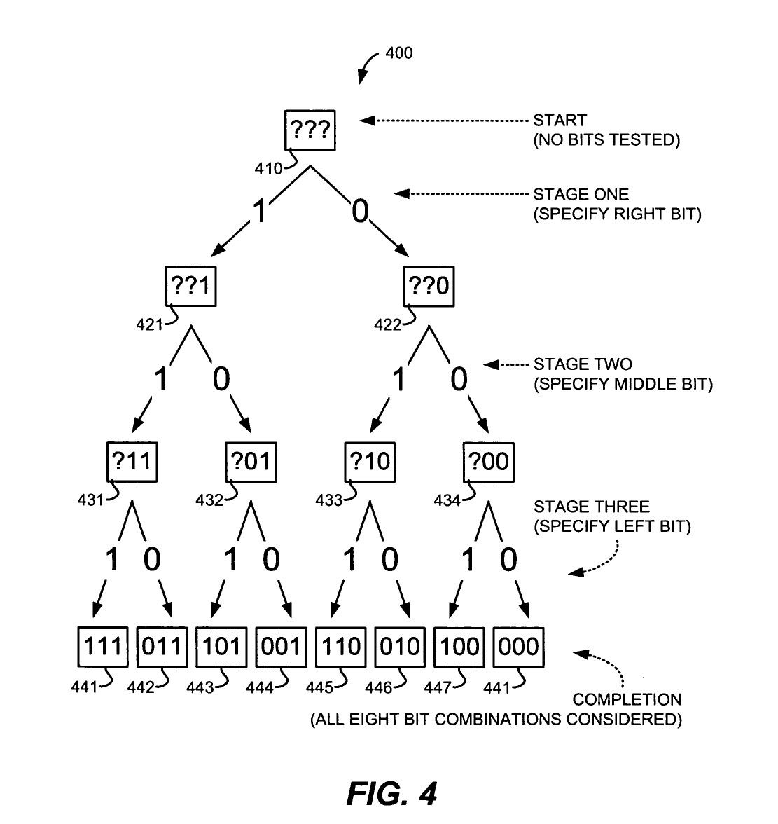

Referring now to FIG. 4, this Figure illustrates a binary search tree 400 according to one exemplary embodiment of the invention. One exemplary embodiment of the inventive scan method employs a binary search method. Search tree 400 illustrates the binary search approach using a UID that is simplified to be only three bits long for illustrative purposes. At the start of the scan (indicated by the top row of the search tree) none of the UID bits have been tested. At stage one of the scan, only the right bit of the bit mask is set. This indicates that only the right bit of the UID should be checked in a query. At stage one of the scan, setting the right bit of the UID to ONE 421 and only the right bit of the mask to ONE will effectively query half of the possible UIDs because any ALD 120 that has a ONE in the right bit of its UID should respond to the query. If only one response is received to this query, then it may be assumed that only one ALD 120 has a UID in the left half of the binary search tree 400 and the searching of that portion of the tree 400 is complete. If instead, no responses were received, then the searching of that half of the tree is also complete because it may be assumed that no ALDs 120 have UIDs in that portion of the tree 400. In either of these cases, an entire half of the search tree 400 has been explored with only a single query.

In the instance where more than one response is received, it may be assumed that more than one ALD 120 has a UID in the left half of the tree. In order to refine the searching of that portion of the tree, the search moves down to stage two. In stage two, two bits are specified in the bit mask, so the queries require for both of those bits to match between the UID of the ALD 120 and the UID of the query. The search tree depicts visually the notion that specifying the second bit further divides the left half of the search tree 421 into two halves of itself one left half 431 and a right half 432. This binary reduction of the search space continues until either no response or only a single response is received for a given query. At that point the presence of all ALDs 120 with UIDs in that portion of the search tree has been examined and that portion of the search can terminate in confidence without having to query every possible UID in that portion of the search tree.

One of ordinary skill in the art will appreciate that a binary search as described above may be generalized into the querying of subsets of the unexplored search space where the binary search example always uses subsets of one half of the prior subset. The selection of subsets that may not be half of the previous search does not depart from the scope or spirit of the invention as the application of the binary search is intended to be exemplary and non-limiting.

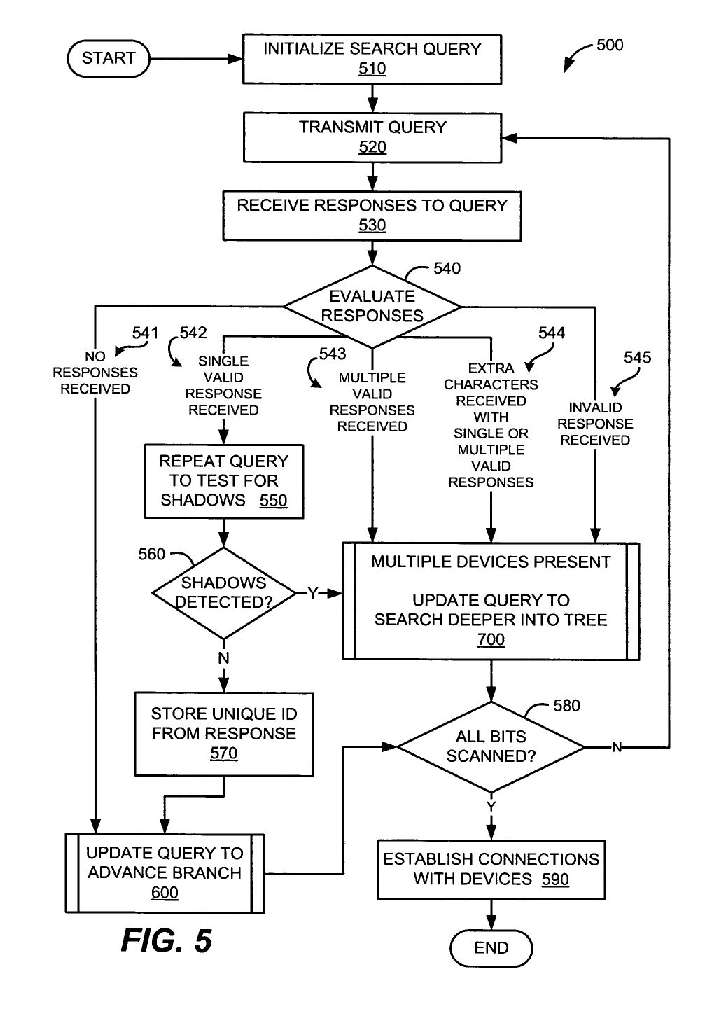

Referring now to FIG. 5, this Figure is a logic flow diagram 500 illustrating exemplary steps for a search method according to one exemplary embodiment of the invention. The search method may begin by initializing a search query in step 510. In one exemplary embodiment, the search query is initialized with only the first bit of the bit mask 380 set to ONE and all other bits of the bit mask set to ZERO. The first bit of the UID (the bit corresponding to the set bit mask bit) is initialized to ZERO. The remaining bits of the UID are not tested given the bit mask as described and may thus be left uninitialized.

In step 520, the query is broadcasted over the network. A broadcast implies that the query is transmitted to all ALDs 120 at once. In one exemplary embodiment, the query is broadcast in the form of a Device Scan Command as discussed above with FIG. 2B. Once the broadcast is received by any ALD 120, it will be compared to the ALDs 120 UID in light of the bit mask as described above and if a match is found the ALD 120 will respond to the local controller 140 in the form of a Device Scan Response.

In step 530, the local controller 140 receives all responses sent to it by ALDs 120. According to one exemplary embodiment, there is a fixed timeout period for receiving responses and the local controller 140 may wait for this time out to run before moving on to evaluate the received responses in step 540. In step 540, there are five different scenarios that may result from the evaluation of the query responses.

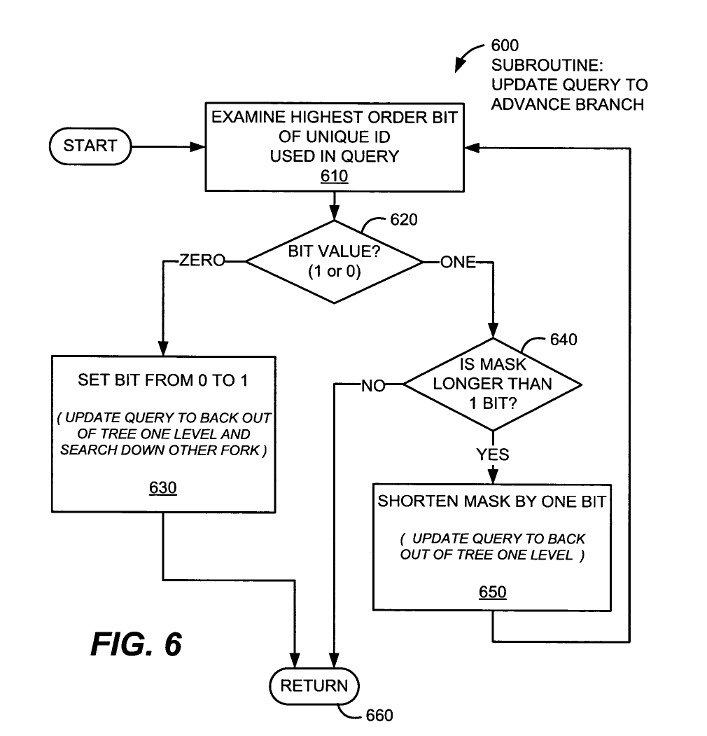

The first possible result of the evaluation of query responses is that no response was received at all 541. In this instance, it may be assumed there are no ALDs 120 present in the portions of the search tree 400 corresponding to the query. If this occurs, the method proceeds to subroutine 600 where the query is updated to investigate another portion of the search tree 400. Exemplary steps for subroutine 600 are discussed below in connection with FIG. 6.

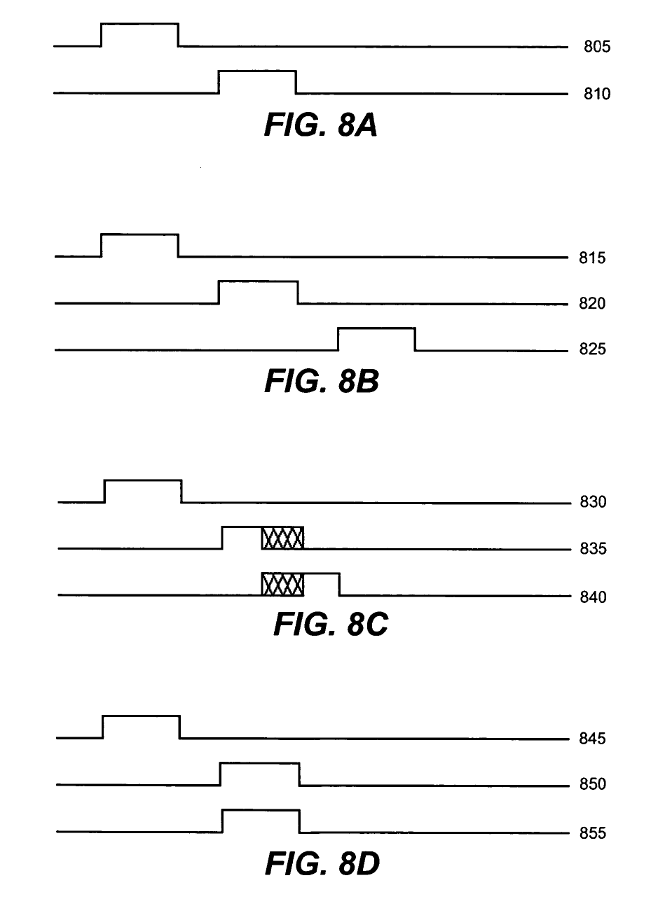

The second possible result of the evaluation of query responses is that a single valid response was received 542. In this instance, the method continues to step 550 where the current query is repeated for a fixed number of iterations to test for shadow response collisions. Shadow response collisions are discussed below in connection with FIG. 8D. In step 560, it is evaluated if any shadow collisions are present. The presence of shadow collisions (or any other collision) requires a deeper exploration of the search tree 400 which is accomplished by transitioning to step 700 which is discussed shortly. If no shadows are detected, then it may be assumed that only the single, non-shadowed, response is present. Thus, only that single ALD is present in the current portion of the search tree 400. Next, in step 570, the UID of that single detected ALD is stored in the list of identified ALDs 120. Then the method proceeds to subroutine 600 where the query is updated to investigate another portion of the search tree 400. Exemplary steps for subroutine 600 are discussed below in connection with FIG. 6.

The remaining three possible results of the evaluation of query responses are: multiple valid responses received 543, extra characters received along with valid response(s) 544, and invalid responses received 545. All three of these results may indicate the presence of multiple ALDs responding to the query. In the case of multiple valid responses received 543, there is obviously more than one responder present. The case of receiving additional characters 544 is a likely indication that there is a response collision between the response of two or more ALDs. Response collisions are as discussed below in connection with FIG. 8C. Lastly, receiving invalid responses 545 may comprise CRC failures, framing errors, or any other received response that fails to be valid. An invalid response is a likely indication that there is a response collision. Response collisions are as discussed below in connection with FIG. 8C.

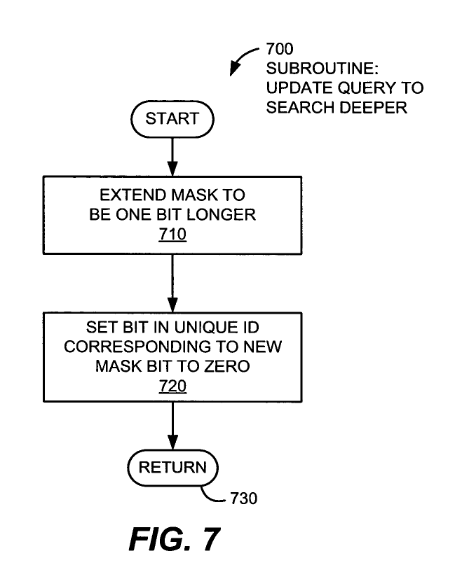

All three of these results 543, 544, and 545, as well as the detection of shadows within the second result 542, indicate the presence of multiple ALDs in the subset of the network currently being queried. All of these cases are handled by transitioning to subroutine 700 which updates the query to search deeper into the search tree 400. Subroutine 700 is discussed below in connection with FIG. 7.

All of the above branches of method 500 have led to either subroutine 600 or subroutine 700. Both of these subroutines 600 and 700 are discussed below in connection with FIGS. 6 and 7 respectively. Both of these subroutines 600 and 700 can update the query used to investigate the network. The updated query comprises a UID 330 and a bit mask 380.

Upon return from either of the subroutines 600 and 700 the method 500 proceeds to decision step 580 where it is evaluated if all desired UID bits have been searched or not. If so, the method 500 proceeds to step 590 where connections are established with all of the ALDs identified by the search and then the method 500 ends. If instead step 580 determines that all desired UID bits have not been searched, the method loops back to step 520 where the query that was updated in subroutine 600 or 700 is transmitted onto the network 130 and the method 500 continues as before.

Referring now to FIG. 6, this Figure is a logic flow diagram 600 illustrating exemplary steps for a subroutine or method to update a search query to advance a branch in a search tree 400 according to one exemplary embodiment of the invention. Step 610 isolates the highest order bit of the UID 330 which is then evaluated to be ONE or ZERO in decision step 620. If in step 620 a ZERO is identified, then the process continues to step 630 where the query is updated so the highest order bit of the UID 330 is changed from ZERO to ONE. This update to the query has the effect of changing the query to examine another portion of the search tree 400 at the same depth as the previous query. For example, referring to FIG. 4, this update would advance query 422 to query 421. This update maintains the mask as only one bit in length but updates the corresponding UID bit from “0” to “1”. Likewise it would advance query 432 to query 431. This update maintains the mask as two bits in length but updates the corresponding UID bits from “01” to “11”. Next, the method proceeds to step 660 where the subroutine ends and returns to where it was invoked.

If in decision step 620, a ONE is identified, then the process continues to decision step 640 where the length of set bits in the bit mask is interrogated. If the bit mask only has one bit set then the decision proceeds to step 660 where the subroutine ends and returns to where it was invoked. If the set bits of the bit mask are more than one bit in length, then decision step 640 continues to step 650 where the query is updated by shortening the mask by one bit. Shortening the mask by one bit has the effect of backing up the tree 400 one level as the search of the lower levels completes. Next, the process loops back to step 610 where the UID is evaluated in light of this update to the bit mask. This evaluation of the updated bit mask will then cause it to advance to a next subset (which is now one stage higher than it was previously) or to back out of the tree one level further and then reevaluate again. The results of this update, referring for example to FIG. 4, would advance query 433 temporarily to query 422, but then to query 421 upon reevaluation. This update shortens the bit mask from two bits to one bit in length, thereby reducing the corresponding UID from “10” to only “0”, but then upon reevaluation, the corresponding UID is updated from “0” to “1”. As another example, the method would advance query 447 temporarily to query 434, but then to query 433 upon reevaluation. This update shortens the bit mask from three bits to two bits in length, thereby reducing the UID from “100” to only “00”, but then upon reevaluation, the UID is updated from “00” to “10”. More interestingly, the method would advance query 445 temporarily to query 433 and then upon reevaluation to query 422 and then upon reevaluation to query 410 and then upon final reevaluation to query 421. This update shortens the bit mask three consecutive times from three bits to one bit in length, thereby reducing the UID from “110” to “0”, but then upon final reevaluation, the UID is updated from “0” to “1”. This is an example of a search that had to drill all the way to the bottom 445 of one half 422 of the search tree 400 before returning to the top 410 to evaluate the second half 421 of the search tree 400.

Referring now to FIG. 7, this Figure is a logic flow diagram 700 illustrating exemplary steps for a subroutine or method to update a search query to search deep into a search tree according to one exemplary embodiment of the invention. Step 710 extends the bit mask 380 one additional bit. This has the effect of drilling down one level into the search tree 400. For example, referring to FIG. 4, this method would advance query 422 to query 434. This query update advances the bit mask from one bit to two bits long and updates the corresponding UID bits from “0” to “00”. As another example, this method would advance query 432 to query 444. This update advances the bit mask from two bits to three bits long and updates the corresponding UID bits from “01” to “001”.

Step 720 initializes the bit corresponding to the newly extended bit mask position to ZERO. Since this initialization and the first initialization in step 510 always start with ZERO, it is possible to advance the search to the next subset by switching the highest bit from ZERO to ONE in step 630. Once a subset of the search tree 400 is completed with the highest UID bit set to ONE then the subset is complete and the mask can be shorted to back out of that portion of the tree as in step 650. This progression from ZERO to ONE to complete is intended as an exemplary embodiment and is not intended to be limiting. In alternative embodiments, the search may proceed in a different order without departing from the spirit or scope of the invention.

FIG. 8A illustrates an exemplary timing diagram of a scenario where a single ALD 120 is responding to a query from a local controller 140. Timing trace 805 represents the transmission of an HDLC frame comprising a Device Scan Command by the local controller 140. Timing trace 810 represents the response frame from an ALD 120 where the frame comprises a Device Scan Response. Since there is only one response, there is no possible response collision.

FIG. 8B illustrates an exemplary timing diagram of a scenario where two ALDs 120 are responding to a query from a local controller 140 without response collision. Timing trace 815 represents the transmission of an HDLC frame comprising a Device Scan Command by the local controller 140. Timing trace 820 represents the response frame from a first ALD 120 where the frame comprises a Device Scan Response. Timing trace 825 represents the response frame from a second ALD 120 where the frame comprises a Device Scan Response. Since the responses of traces 820 and 825 do not overlap at all they will both be received by the local controller 140 without response collision. Both responses will be valid responses.

FIG. 8C illustrates an exemplary timing diagram of a scenario where two ALDs 120 are responding to a query from a local controller 140 and the responses collide. Timing trace 830 represents the transmission of an HDLC frame comprising a Device Scan Command by the local controller 140. Timing trace 835 represents the response frame from a first ALD 120 where the frame comprises a Device Scan Response. Timing trace 840 represents the response frame from a second ALD 120 where the frame comprises a Device Scan Response. Since the responses of traces 835 and 840 overlap there will be a response collision.

The response collision will be detected at the local controller 140 in one of two ways. If the overlapping portions of traces 835 and 840 cause interference and generate noise, then the local controller 140 may receive an invalid packet due to CRC failure, framing failure, or other failure resulting in an invalid response frame being received. The second way that the local controller 140 may detect the response collision is when one of the ALDs 120 is closer to the local controller 140 or has a higher drive current on the bus such that it overpowers the other ALD 120. In such a case the local controller 140 may receive a valid response from the overpowering ALD 120, but then receive extra additional characters. These are the extra characters are identified in result 544 of step 540.

FIG. 8D illustrates an exemplary timing diagram of a scenario where two ALDs 120 are responding to a query from a local controller 140 and the responses collide with timing such that they are exactly, or nearly exactly, aligned. Timing trace 845 represents the transmission of an HDLC frame comprising a Device Scan Command by the local controller 140. Timing trace 850 represents the response frame from a first ALD 120 where the frame comprises a Device Scan Response. Timing trace 855 represents the response frame from a second ALD 120 where the frame comprises a Device Scan Response.

The perfect, or nearly perfect, coincidence of response frames in timing traces 850 and 855 represent the shadow scenario addressed in step 550. When one of the two responding ALDs 120 is closer to the local controller 140 or has a higher drive current or is in some other way capable of overpowering the second responding ALD 120, the response from the first ALD 120 may be received as a valid response and the response of the second ALD 120 may be completely missed and is said to be in the shadow of the first response.

This rare circumstance is addressed by the shadow repetition described for step 550 by repeating the query of any apparently valid response for a fixed number of times, it can be more likely that the two responses will not coincide exactly in at least one of the repetitions. In a repetition where the temporal coincidence of the two responses is not perfect, the overlap of the shadow will be detected as a case of extra characters received along with a valid response. As discussed above, such an extra characters scenario may cause the scan to drill down deeper into the subset of the search space in order to search for the additional responding ALDs 120 with higher resolution.

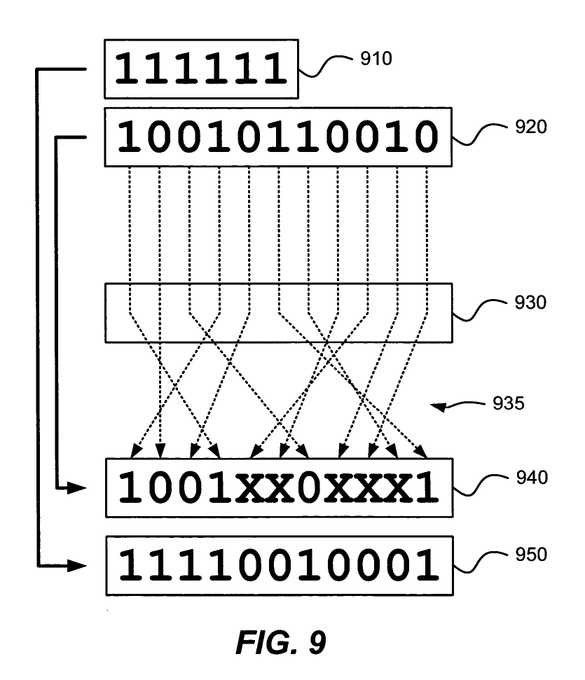

Referring now to FIG. 9, this Figure illustrates a bit translation mapping 930 to generalize the search progression according to one exemplary embodiment of the invention. In the method steps of the exemplary embodiments presented above, the bit mask 380 extends and retracts in one bit increments to move deeper into the search tree 400 or to step back a level in the search tree. Such an embodiment will search the UID space bitwise from left to right or right to left. Such embodiments are exemplary and not limiting. The use of a bit translation mapping 930 may generalize this left-to-right or right-to-left progress to any arbitrary progression on the mask or across the bit ordering of the UID 330.

The bit translation mapping 930 is applied to the query just before it is transmitted. The original UID 920 and original bit mask 910 are bit swapped according to the translation mapping 930 to generate a UID 940 and bit mask 950 that are actually transmitted. This bit swapping can be arbitrary as shown in the figure by 935, or may merely reverse the search order. Such swapping allows the basic search method to remain unchanged in the generation of original UID 920 and original bit mask 910, but application of the translation mapping 930 may result in any arbitrary ordering. This generalized ordering of the search bits in the UID search space can be used with stored translation mappings to use in specific instances where there is a priori information about some nature of the UID due to the practices or idiosyncrasies of specific vendors for ALDs 120.

An example of a vendor idiosyncrasy is where a vendor may not use all of the bits in the UID. ALDs from this vendor may not respond when the unused bits are being queried as ONE or when they are queried as ZERO. In other words, those unused bits must not be indicated within the bit mask for that specific ALD to respond to the device scan. Altering the order of a scan, which may be accomplished using translation mapping 930, may ensure that such unused bits are not ever specified in a bit mask in such a way that would invalidate other queries and result in missed devices at the end of the device scan method.

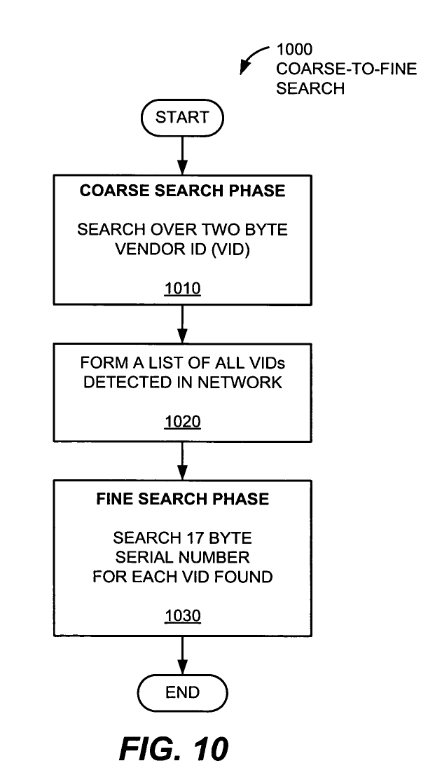

Referring now to FIG. 10, this Figure is a logic flow diagram illustrating exemplary steps for a coarse-to-fine search method according to one exemplary embodiment of the invention. In step 1010, the coarse search can be performed over only the two byte (sixteen bit) vendor ID 320. This coarse search may be carried out using substantially the same method of the more generalized search method 500. From the results of this coarse subset of the search space, all sixteen bit vendor IDs that were identified may be examined to form a list of all vendor IDs ion the network in step 1020. Then, in step 1030, the fine phase of the search may be carried out. In the fine phase of the search, a more refined search is made under each identified vendor ID. This fine search may be carried out using substantially the same method of the more generalized search method 500.

In one exemplary embodiment of the method illustrated in FIG. 10, the order of the steps may be altered as to interleave the fine search step within the coarse search. That is, the fine search 1030 for each vendor ID may take place as each vendor ID is identified by the coarse search 1010. This differs from the example illustrated in FIG. 10 where the fine searching is done for all vendors IDs after all of the coarse searching is complete and all vendor IDs have been identified. The interleaved approach may, in some instances, complete more quickly. Such reordering, parallelizing, or interleaving of steps, where possible, may be performed without departing from the spirit or scope of the invention.

The need in the art for a method and system that can discover devices, such as ALDs, coupled to a network when two or more responses from respective devices collide can be addressed by the method illustrated in FIG. 5. This need may first be addressed by determining the query result scenarios that imply response collisions such as response shadows 560, multiple valid responses 543, extra characters 544, and invalid responses 545. Secondly, the need may be met by providing for the refinement of search parameters to resolve colliding network responses 700.

The need in the art for a method and system that can discover devices, such as ALDs, coupled to a network in an efficient manner so that devices are identified in a short period of time is addressed by the general search tree 400 pruning notions of method 500 as well as the specific query update steps of methods 600 and 700. The proper updating of search queries in order to avoid unnecessary queries may significantly reduce the time and complexity of a search. Search efficiency may further be severed by the coarse-to-fine search approach provided by method 1000.

Other alternative embodiments of the inventive method will become apparent to one of ordinary skill in the art to which the present invention pertains without departing from its spirit and scope. Thus, although this invention has been described in exemplary form with a certain degree of particularity, it should be understood that the present disclosure has been made only by way of example and that numerous changes in the details of implementation and application and the combination and arrangement of steps or elements may be resorted to without departing from the spirit or scope of the invention. Accordingly, the scope of the present invention is defined by the appended claims rather than the foregoing description.

What is claimed is:

1. A method for discovering the addresses of one or more nodes on a network comprising:
initializing a node address query for searching a set of characters of a node address;
transmitting the node address query to one or more nodes on the network;
receiving one or more responses to the query from one or more nodes on the network;
determining if more than one node on the network responded to the query by determining at least one of:
whether extra characters are being received with a valid response;
whether an invalid response is being received; and
whether a response is being shadowed by another response; and
if more than one node on the network responded to the query, then adjusting the set of characters to search a larger set of characters of a node address, and then returning to the transmitting step using the query with the adjusted set of characters.

2. The method of claim 1, further comprising if no responses to the query were received, then adjusting the set of characters of the query to search a different set of characters of a node address.

3. The method of claim 1, wherein the query comprises a bit mask related to the node address of the query.

4. The method of claim 1, wherein the node address comprises a unique identifier of a device.

5. The method of claim 1, further comprising:
determining if a single node has been identified based on a received response; and
if a single node has been identified, storing the node address of the identified single node.

6. The method of claim 1, wherein determining whether one response is being shadowed by another response comprises, repeating for a number of iterations, any query that generated a valid response and examining responses to repeated queries by determining at least one of:
whether extra characters are being received with the valid response; and
whether an invalid response is being received.

7. A method for discovering unique identifiers of devices coupled to a network and a structure that supports one or more antennas, the method comprising:
transmitting a query for searching a set of unique identifiers of a device to one or more devices on the network and coupled to the structure;
receiving one or more responses to the query from one or more devices on the network;
determining if more than one device on the network responded to the query by determining one of:
whether extra characters are being received with a valid response;
whether an invalid response is being received; and
whether a response is being shadowed by another response;
if more than one device on the network responded to the query, then adjusting the set of unique identifiers to search a larger set of unique identifiers, and then returning to the transmitting step using the query with the adjusted set of unique identifiers.

8. The method of claim 7, further comprising initializing the query.

9. The method of claim 7, wherein the structure comprises at least one of a tower and a building.

10. The method of claim 7, wherein a device comprises at least one of: an antenna, a device for moving an antenna, an amplifier, a light, an amplifier, a monitoring device, a measurement instrument, a device for controlling radio frequency signal phase, and a programmable digital control device.

11. The method of claim 7, further comprising:
determining if a single device has been identified based on a received response; and
if a single device has been identified, storing the serial number of the identified device.

12. The method of claim 11, wherein determining if a single device has been identified further comprises determining if there is a match between the query and a serial number assigned to a device.

13. The method of claim 7, further comprising if no responses to the query were received, then adjusting the set of characters of the query to search a different set of characters of a serial number.

14. The method of claim 7, wherein the query comprises a bit mask related to the serial number of the query.

15. The method of claim 7, wherein determining whether one response is being shadowed by another response comprises, repeating for a number of iterations, any query that generated a valid response and examining responses to repeated queries by determining at least one of:
whether extra characters are being received with the valid response; and
whether an invalid response is being received.

16. The method of claim 7, wherein transmitting a query further comprises transmitting a query from a controller remote from the structure.

17. The method of claim 7, wherein transmitting a query further comprises transmitting a query from a controller remote from the structure to a controller proximate to the structure.

18. A method for discovering serial numbers of devices coupled to a network and a structure that supports one or more antennas, the method comprising:
transmitting a query for searching a set of characters of a serial number of a device to one or more devices on the network and coupled to the structure;
receiving one or more responses to the query from one or more devices on the network;
determining if responses from two or more devices are present; and
if responses from two or more devices are present, then adjusting the set of characters to search a larger set of characters of the serial number, and then returning to the transmitting step using the query with the adjusted set of characters.

19. The method of claim 18, further comprising initializing the query.

20. The method of claim 18, wherein determining if responses from two or more devices are present further comprises determining at least one of:
whether extra characters are being received with a valid response;
whether an invalid response is being received; and
whether a response is being shadowed by another response.

21. The method of claim 18, wherein the structure comprises at least one of a tower and a building.

22. The method of claim 18, wherein a device comprises at least one of: an antenna, a device for moving an antenna, a light, an amplifier, a monitoring device, a measurement instrument, a device for controlling radio frequency signal phase, and a programmable digital control device.

23. The method of claim 18, further comprising:
determining if a single device has been identified based on a received response; and
if a single device has been identified, storing the unique identifier of the identified device.

24. The method of claim 18, wherein determining if a single device has been identified further comprises determining if there is a match between the query and a unique identifier assigned to a device.

25. The method of claim 18, further comprising if no responses to the query were received, then adjusting the set of unique identifiers of the query to search a different set of unique identifiers.

26. The method of claim 18, wherein the query comprises a bit mask related to the unique identifier of the query.

27. The method of claim 20, wherein determining whether a response is being shadowed by another response comprises, repeating for a number of iterations, any query that generated a valid response and examining responses to repeated queries by determining at least one of:
whether extra characters are being received with the valid response; and
an whether an invalid response is being received.

28. The method of claim 18, wherein transmitting a query further comprises transmitting a query from a controller remote from the structure.

29. The method of claim 18, wherein transmitting a query further comprises transmitting a query from a controller remote from the structure to a controller proximate to the structure.

30. The method of claim 18, wherein transmitting a query further comprises transmitting a query from a computer remote from the structure to a computer proximate to the structure.

31. A computer system for discovering the addresses of nodes on a network, comprising:
a processing unit;
a memory storage device; and
a program stored in the memory storage device for providing instructions to the processing unit,
the processing unit responsive to the instructions of the program, operable for:
transmitting a node address query to one or more nodes on the network;
receiving one or more responses to the query from one or more nodes on the network;
determining if two or more responses are present; and
if two or more responses are present, then adjusting the set of characters to search a larger set of characters of a node address, and then returning to the transmitting step using the query with the adjusted set of characters.

32. The computer system of claim 31, wherein the processing unit is further operable for initializing the query.

33. The computer system of claim 31, wherein determining if two or more responses are present further comprises determining at least one of:
whether extra characters are being received with a valid response;
whether an invalid response is being received; and
whether a response is being shadowed by another response.

34. The computer system of claim 31, wherein the processing unit is further operable for:
determining if a single node has been identified based on a received response; and
if a single node has been identified, storing the node address of the identified single node in the memory storage device.

35. The computer system of claim 31, wherein the processing unit is further operable for determining if no responses to the query were received, and then adjusting the set of characters of the query to search a different set of characters of a node address.

36. The computer system of claim 31, wherein the query comprises a bit mask related to the node address of the query.

37. The computer system of claim 31, wherein the node address comprises a serial number of a device.

38. The computer system of claim 34, wherein determining if a single node has been identified further comprises determining if there is a match between the query and actual node address assigned to the node.

39. The computer system of claim 33, wherein determining whether one response is being shadowed by another response comprises, repeating for a number of iterations, any query that generated a valid response and examining responses to repeated queries by determining at least one of:
whether extra characters are being received with the valid response; and
an whether an invalid response is being received.

40. A computer system for discovering the addresses of nodes coupled to a network and a structure for supporting one or more antennas, the computer system comprising:
a processing unit;
a memory storage device; and
a program stored in the memory storage device for providing instructions to the processing unit,
the processing unit responsive to the instructions of the program, operable for:
transmitting a query for searching a set of characters of a serial number of a device to one or more devices coupled to the network and coupled to the structure;
receiving one or more responses to the query from one or more devices on the network;
determining if responses from two or more devices are present; and
if responses from two or more devices are present, then adjusting the set of characters to search a larger set of characters of the serial number, and then returning to the transmitting step using the query with the adjusted set of characters.

41. The computer system of claim 40, further comprising initializing the query.

42. The computer system of claim 40, wherein determining if responses from two or more devices are present further comprises determining at least one of:
whether extra characters are being received with a valid response;
whether an invalid response is being received; and
whether a response is being shadowed by another response.

43. The computer system of claim 40, wherein the structure comprises at least one of a tower and a building.

44. The computer system of claim 40, wherein a device comprises at least one of: an antenna, a device for moving an antenna, a light, an amplifier, a monitoring device, a measurement instrument, a device for controlling radio frequency signal phase, and a programmable digital control device.

45. The computer system of claim 40, wherein the processing unit receives the query from a computer positioned remote from the structure.

46. The computer system of claim 40, wherein the processing unit is further operable for:
determining if a single device has been identified based on a received response; and
if a single device has been identified, storing the serial number of the identified device in the memory storage device.

47. The computer system of claim 40, wherein determining if a single device has been identified further comprises determining if there is a match between the query and a serial number assigned to a device.

48. The computer system of claim 40, wherein the processing unit is further operable for determining if no responses to the query were received, then adjusting the set of characters of the query to search a different set of characters of a serial number.

49. The computer system of claim 40, wherein the query comprises a bit mask related to the serial number of the query.

50. The computer system of claim 42, wherein determining whether a response is being shadowed by another response comprises, repeating for a number of iterations, any query that generated a valid response and examining responses to repeated queries by determining at least one of:
whether extra characters are being received with the valid response; and
an whether an invalid response is being received.
